(19) United States
(12) Patent Application Publication
(10) Pub. No.: US 2009/0077136 A1
(43) Pub. Date: Mar. 19, 2009

(54) FILE MANAGEMENT SYSTEM, FILE MANAGEMENT METHOD, AND FILE MANAGEMENT PROGRAM

(76) Inventors: Hiromi Igawa, Kawasaki (JP); Masato Arai, Yokohama (JP); Yoshinobu Tanigawa, Yokohama (JP); Satoshi Kai, Yokohama (JP); Tomochika Tomiyama, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/195,497

(22) Filed: Aug. 21, 2008

(30) Foreign Application Priority Data
Sep. 18, 2007 (JP) 2007-241393

(51) Int. Cl. G06F 17/30

(52) U.S. Cl. 707/200; 707/E17.005

(57) ABSTRACT

To identify a storage medium storing an electronic file, as a location of the electronic file, and to detect a location move of a file stemming from a replacement of a storage medium, a file management system 100 includes a log acquisition unit 110: detecting an event having occurred on a file stored in a storage medium; checking, with a table, pieces of information of logical paths of locations of the file before and after the event; identifying pieces of medium identification information of storage media in which the file is located before and after the event are identified; and then storing the pieces of medium identification information in a terminal log database as location information of the file.

### INCORPORATION BY REFERENCE

This application claims priority based on a Japanese patent application, No. 2007-241393 filed on Sep. 18, 2007, the entire contents of which are incorporated herein by reference.

### BACKGROUND

This invention relates to a file management system, a file management method, and a file management program. More particularly, the present invention relates to a file management technique capable of identifying a storage medium storing a file, as location information of the file having experienced a copy or move between storage media, in the course of tracking each file under a management of an organization.

Recently, risk management for information leakage, lawsuit, and proof of business legitimacy has been required in various organizations. A target of such risk management is often electronic files. Since copy and move of electronic files are easy, files containing the same contents can easily be spread. This characteristic of electronic files causes the following problems.

### (1) Regarding Information Leakage

When information leakage occurs, it is necessary to identify a path of the information leakage and to find the scope of damage due to the leakage. However, if the locations of scattered pieces of information are not certain, not only identification of a leakage path but also identification of leaked information is difficult. Even when no information leakage has occurred, the uncertainty of the locations of pieces of information always poses a risk that information may leak from anywhere at any point.

### (2) Regarding Lawsuit Risk

For example, according to Federal Rules of Civil Procedure (FRCP), providing rules governing civil procedure in the U.S., information to be treated as an evidence in the lawsuit must be disclosed between parties of the lawsuit before the trial. To follow the system, the locations and contents of the information to be an evidence in the lawsuit need to be quickly identified. However, since individuals these days store information in multiple media, not only their desktop PCs but also shared servers, portable media, and the like, examining all of these storage media is inefficient. In addition, narrowing down the media to be examined takes time because it is difficult to accurately figure out the medium storing each piece of information.

### (3) Regarding Proof of Business Legitimacy:

In order to verify business legitimacy, it is necessary to visualize information involved in the business and operations performed on the information. However, it is difficult to verify the legitimacy in a current condition that neither the location nor the use of information can be certain.

To address the above problems, performing manual examinations is a method for figuring out the location of a file. For example, in a case of dealing with lawsuit risk, a lawyer conducts hearing. In this means, the lawyer identifies the information to be an evidence by: firstly identifying, through the hearing, people most likely to have a file whose location is desired to be identified; then identifying storage media which are most likely to have been used by any of the identified people, from among storage media scattered in the organization; subsequently searching the identified storage media for files; and finally reading the contents of files which have a possibility to be an evidence in the lawsuit. However, in this means, the following problems cannot be solved.
(1) Since an examination is conducted by a person, it takes time to find files to be read.
(2) Since the accuracy in identifying related people and files depends on the experience of the person conducting hearing and on respondents' memories, acquired information is not always reliable, so that some facts may fail to be included in identification results.

When an information leakage occurs, hearing is performed to identify the path of the information leakage and also leaked information as in the case of dealing with lawsuit risk. For this reason, the accuracy in tracking information depends on human memories.

Further, a technique disclosed in “LanScope Cat operation process log screen” in “LanScope Cat,” Internet <URL:http://www.motex.co.jp/cat5/process.shtml> from MOTEX Co., Ltd. (hereinafter simply referred to as document 1) and the like is an example of a method of technically managing information locations. In a conventional technique, when a file is moved, a file ID unique in an organization and an absolute path name to be location information of the file are added to the file to monitor location information of the file even in a move destination. With this technique, moves of a document file can be tracked.

However, information under the management of an organization is frequently copied or moved between media for data migration due to use of portable media or replacement of devices. Such being the case, in order to identify a storage medium for information integrity in response to a monitoring request in the conventional technique, it is necessary to track not only information (the location of which is identified by the path name of a logical drive), but also moves of the information between media storing the information.

However, file management performed in the conventional technique does not include storage medium identification, portable media are thus not identified individually. Accordingly, when an individual uses several portable media, all the portable media inserted into and removed from the same interface of the same client can only be identified by the same logical drive name, and cannot be individually identified. Further, even when an absolute path name that follows a drive letter is obtained as position information of a file, moves of the file due to replacement of a storage medium or the like cannot be detected. Further, when multiple storage media are coupled, it is difficult to identify a physical medium as the location of the file.

To address this problem, there is a technique (refer to document 1) by which the coupling history of a portable medium can be acquired.

### SUMMARY OF THE INVENTION

In the above-described conventional technique (document 1), drive letter information and time of the event in which a portable medium is coupled to a PC can be acquired as a log. However, this does not enable individual identification of the portable medium. Thus, desired have been a technique for quickly identifying a storage medium storing an electronic file while depending on human experiences and memories as little as possible, and a technique for detecting and managing moves of a file or the like due to replacement of a storage medium.

The present invention has been made in light of the above-described problems, and a main object of the present invention is to provide a technique capable of identifying a storage medium storing an electronic file, as a location of the electronic file, and also capable of detecting a location move of a file due to coupling/uncoupling of and /or a replacement of a storage medium.

A file management system of the present invention for solving the problems is that a file management system, managing locations of files in a computer system, includes: a storage storing a table in which a correspondence relationship between medium identification information enabling a unique identification of a storage medium and a logical path set for the storage medium is described, and storing a terminal log database in which information on file location is stored; and an arithmetic unit executing a log acquisition process in which an event having occurred on a file stored in the storage medium is detected, pieces of information on logical path of the file location before and after the event, respectively, are checked with the table, pieces of medium identification information of storage media in which the file is located before and after the event, respectively, are identified, and the pieces of medium identification information are then stored in the terminal log database as the information on file location.

According to the above file management system, not only a logical path but also medium identification information (e.g., a serial number, that is, information enabling a unique identification of a corresponding object) serving as individual information of a storage medium (e.g., a hard disk device built into a PC, a type of portable storage media such as a USB memory) are acquired. Hence, a location of the electronic file can securely be managed without any influence of plugging-in/out of the storage medium. Accordingly, even storage media storing the electronic files can be identified and tracked as locations of electronic files stored in various storage media, so that a storage medium storing search target information can be quickly and securely identified without depending on human experiences and memories as in a conventional case.

In the above-described file management system, before the log acquisition process, a table creation process may be performed in which: a storage medium set for each logical path is accessed to acquire medium identification information; a correspondence relationship between each of the logical paths and the acquired medium identification information is identified; and to the table is thereby generated or updated. According to this file management system, even in a state where a storage medium is coupled to or uncoupled from a coupling destination terminal in a stop period of the log acquisition process, this state can securely be reflected on the table. Accordingly, the table on which the latest state of the storage medium is reflected can be used for the log acquisition process, so that reliability of a process result is assured.

Further, in the log acquisition process of the above file management system, when the event is a move or a copy of the file, pieces of medium identification information of corresponding storage media serving respectively as a move destination and a move source of the file, or serving respectively as a copy destination and a copy source of the file, may be stored in the terminal log database. According to this file management system, pieces of information (not only a logical path but also medium identification information of the storage medium) on a move destination, a move source, and the like of a corresponding file can be acquired at the same time, and can be thereby employed as management targets. Accordingly, secure location management of electronic files can be performed without failing to acquire any location information which may change at a time when an event occurs.

Further, in the log acquisition process of the above file management system, pieces of PC identification information enabling unique identifications of terminals to which media with the file located therein before and after the event may be acquired respectively from the terminals; and the pieces of PC identification information and a file name of the file on which the event has occurred may be stored, as the information of file location, in the terminal log database, in addition to the pieces of medium identification information of the storage media. According to this file management system, in addition to identification of a storage medium as a location of an electronic file, a terminal which is a coupling destination of the storage medium is also uniquely identified. In this manner, for example, the terminal is also identified at the time when the location of the electronic file is identified and, consequently, identification of a user (user of the terminal) of the electronic file can also be easier.

Further, in the above file management system, an information asset list generation process may be performed in which: the location information is acquired from the terminal log database; an entry is generated, for each event of each file, the entry including a name of the file, medium identification information of a storage medium storing the file, and PC identification information of a terminal coupled to the storage medium; and the entry is then stored in an information asset list included in the storage. According to this file management system, the location information acquired in the log acquisition process can be organized and summarized for each file that is a management target. For example, when a person in charge performs a search of a location or the like of a electronic file, the history of locations of the corresponding electronic file can be easily seen only by checking entries listed in the order of a series of events.

Further, in the information asset list generation process of the file management system, the information asset list may be created for each file, and the entry may be stored separately for each file in the information asset list. According to this file management system, management of location information can be completed for each electronic file. Accordingly, since updating or the like is not performed with pieces of location information on various electronic files, data management can be performed efficiently. In addition, since the number of search targets can easily be reduced by narrowing down corresponding electronic files by using attributes and the like thereof, search can be performed efficiently.

Further, in the information asset list generation process of the file management system, when the information asset list is searched for a file name included in the entry and the entry is not found in the information asset list, a new information asset list is created. According to this file management system, multiple registrations of information asset lists and entries can be prevented, so that efficiency in management of location information can be improved.

Further, in the log acquisition process of the file management system, an occurrence of an event of a coupling or an uncoupling between a terminal and a storage medium may be detected, and storage medium information may be stored in the terminal log database, the storage medium information including information on the occurrence time of the event associated with each of medium identification information of the storage medium and PC identification information of the terminal to which the storage medium is coupled. According to this file management system, in addition to the change of locations of an electronic file, a location state of a storage medium that is a storage destination of an electronic file can also securely be saved.

Further, in the file management system, a storage medium list generation process may be performed in which: the storage medium information is acquired from the terminal log database; an entry is generated the entry including information on an occurrence time of an event of a coupling or an uncoupling between a terminal and the storage medium associated with each of medium identification information of the storage medium and the PC identification information of the terminal to which the storage medium is coupled; and the entry is stored in a storage medium list included in the storage.

According to this file management system, in addition to the change of location states of an electronic file, a location state of a storage medium that is a storage destination of the electronic file can also be set as a management target. Accordingly, for example, when a storage medium is a portable type and is hence frequently attached to or detached from a terminal, a location of an electronic file stored therein can securely be saved together with the medium identification information of the storage medium.

Further, in the file management system, a discard management process may be performed in which: medium identification information of a storage medium to be discarded is acquired through an input interface; discard information is registered in an entry of the storage medium list corresponding to the storage medium to be discarded; the medium identification information of the storage medium to be discarded is checked with the information asset list; and deletion information is registered in an entry of a file stored in the storage medium. According to this file management system, not only in a state in which a storage medium is detached from a terminal, but also in a state in which a storage medium itself is discarded, a location of an electronic file stored in the storage medium can securely be managed.

Further, in the file management system, a search process may be performed in which: a search request including date-and-time information and a file name is received through an input interface; a search is performed on the information asset list by using, as keys, the date-and-time information and the file name included in the search request; a storage medium storing a file corresponding to the file name at date and time corresponding to the date-and-time information is identified; and information on the storage medium thus identified is outputted to an output interface as location information on the file at the date and time. According to this file management system, in response to a search request, not only a logical path as in a conventional case but also a storage medium can be identified as location information on a corresponding file, and such location information can be provided to a user.

Further, in the search process of the above file management system, pieces of the location information of each file acquired by the search may be listed for each storage medium, and are then outputted to the output interface, in the search process. According to this file management system, the change of a location state of an electronic file is summarized for each storage medium to be provided to the user. Accordingly, a search request or the like in which storage media are narrowed down can be efficiently handled.

Further, in the above file management system, when a file access monitoring process is performed on the storage medium, the file access monitoring process including that only a file access based on a logical path is monitored without using medium identification information of the storage medium as a process target and that a file access log including event information on a file access having occurred, a logical path, and date-and-time information is acquired, a storage medium monitoring process and a log merging process may be performed. In the storage medium monitoring process, an event of a coupling or an uncoupling of the storage medium is monitored, a storage medium log including date-and-time information of the coupling or uncoupling, medium identification information of the storage medium, and information of a logical path set for the storage medium is acquired, and the acquired storage medium log is stored in the storage. In the log merging process, a storage medium log corresponding to the date and time and the logical path indicated by the file access log is identified; the storage medium log thus identified and the file access log are merged, and the terminal log including the event of the file access having occurred at the date and time, the name of a logical path serving as a destination of the event, and medium identification information of the storage medium is generated. According to this file management system, even for a storage medium to which only a conventional file management method is applied, the terminal log of the present invention can be acquired by performing the above log merging process. Accordingly, even for an existing computer system in which a conventional file management system is installed, the file management system of the invention can easily be applied, and the same effect as that achieved by the invention can be obtained.

In addition, the file management system may be implemented as a single computer device, or the above-described processes may be performed by separated devices (a group of which serves as the file management system) in cooperation. For example, it can be assumed that the log acquisition process, the table creation process, the storage medium monitoring process, and the log merging process are each performed by a terminal coupled to a corresponding storage medium, and that the information asset list generation process, the storage medium list generation process, the discard management process, and a search process are performed by a server unit for file management.

A file management method of the invention is that a computer, managing locations of files in a computer system, includes a storage storing a table in which a correspondence relationship between medium identification information enabling a unique identification of a storage medium and a logical path set for the storage medium is stored, and storing a terminal log database in which information on file location is stored, and an arithmetic unit, and the computer executes a log acquisition process in which an event having occurred on a file stored in the storage medium is detected, pieces of information on logical path of the file location before and after the event, respectively, are checked with the table, pieces of medium identification information of a storage medium in which the file is located before and after the event, respectively, are identified, and the pieces of medium identification information are then stored in the terminal log database as the information on the file location.

According to the above file management method, not only a logical path but also medium identification information (e.g., a serial number, that is, information uniquely identifying a corresponding object) which is individual information of a storage medium (e.g., a hard disk device built into a PC, a type of portable storage media such as a USB memory, or the like) are also acquired for an event (updating, copy, move, or the like) occurring on an electronic file which is a management target, so that a location of an electronic file can securely be managed without any influence of plugging-in/out of the storage medium and the like. Accordingly, even storage media can be identified and tracked as locations of an electronic file in various storage media, so that a storage medium storing information that is a search target can quickly and securely be identified without depending on human experiences and memories as in a conventional case.

Further, a file management program of the invention causes a computer including, for managing locations of files in a computer system: a storage storing a table in which a correspondence relationship between medium identification information enabling a unique identification of a storage medium and a logical path set for the storage medium is stored, and storing a terminal log database in which information on file location is stored; and an arithmetic unit, to execute the steps of detecting an event occurring on a file stored in the storage medium; checking, with the table, pieces of information on logical path of the file location before and after the event, respectively; identifying pieces of medium identification information of storage media in which the file is located before and after the event, respectively; and storing the pieces of medium identification information in the terminal log database as the information on file location.

In accordance with the above file management program, not only a logical path but also medium identification information (e.g., a serial number, that is, information uniquely identifying a corresponding object) which is individual information of a storage medium (e.g., a hard disk device built into a PC, a type of portable storage medium such as a USB memory, or the like) are also acquired for an event (updating, copy, move, or the like) occurring on an electronic file which is a management target, so that a location of an electronic file can securely be managed without any influence of plugging-in/out of the storage medium and the like. Accordingly, even storage media can be identified and tracked as locations of an electronic file in various storage media, so that a storage medium storing information that is a search target can quickly and securely be identified without depending on human experiences and memories as in a conventional case.

In addition to the above, problems and solving methods thereof disclosed in this application will be clear by referring to description of embodiments of the present invention and the accompanying drawings.

According to the present invention, it is possible to identify a storage medium storing an electronic file can be identified as a location of the electronic file, and to detect a location move of a file stemming from a replacement of a storage medium.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a configuration diagram of a file management system according to a first embodiment.

FIG. 2 is a block diagram of a client (a terminal).

FIG. 3 is a diagram showing an example of a data structure of a terminal log.

FIG. 4 is a diagram showing an example of a data structure of an information asset list.

FIG. 5 is a diagram showing an example of a data structure of a storage medium list.

FIG. 6 is a diagram showing a process flow example 1 of a file management method of the first embodiment.

FIG. 7 is a diagram showing a process flow example 2 of the file management method of the first embodiment.

FIG. 8 is a diagram showing a process flow example 3 of the file management method of the first embodiment.

FIG. 9 is a view showing an example 1 of a search result window.

FIG. 10 is views showing an example 2 of the search result window.

FIG. 11 is a diagram showing a log acquisition procedure according to a second embodiment.

FIG. 12 is a configuration diagram of a file management system according to a third embodiment.

FIG. 13 is a configuration diagram of a file management system according to a fourth embodiment.

### DETAILED DESCRIPTION OF THE EMBODIMENTS

### System Configuration (First Embodiment)

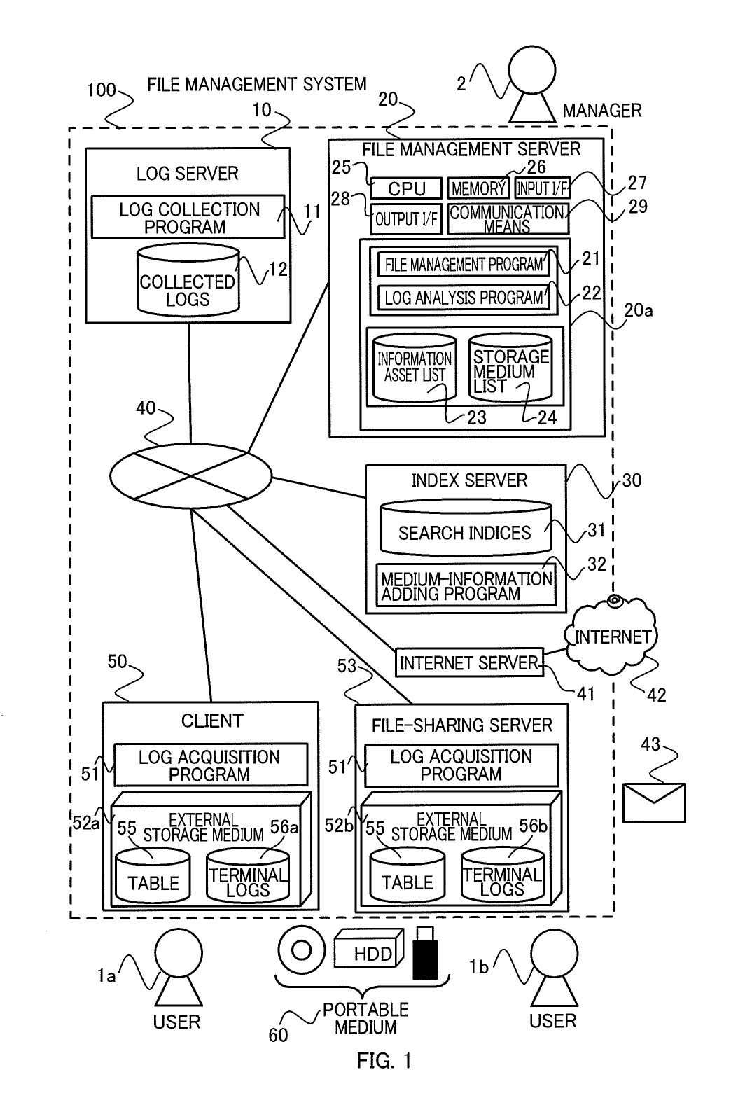

A first embodiment of this invention will be described in detail below with reference to the accompanying drawings. FIG. 1 is a network configuration of a file management system according to the first embodiment. A file management system 100 shown in FIG. 1 has a configuration in which a log server 10, a file management server 20, an index server 30, an internet server 41, and one or more clients 50 or file-sharing servers 53 are each coupled to a network 40 with or without wires.

The internet server 41 is an e-mail server relaying transmission/reception of e-mails 43 within the network 40 or through the Internet and storing transmitted/received e-mails, or is a proxy server relaying Web communications with the Internet 42, or the like.

The index server 30 regularly checks (in the same manner as a robot function of a general search engine, for example) files stored in a storage of the client 50 or the e-mails 43 stored in the internet server 41, and indexes (search indices) the contents of the files or e-mails, so that a high-speed search can be performed only by designating a keyword or the like. In the index server 30, at the time of outputting a search result by using information stored in the search index 31, the medium-information adding program 32 operates to add medium identification information of a storage medium, which is location information of the file, to the search result.

Further, one or more external storage media 52a and 52b are coupled to the client 50 or the file-sharing server 53, and a portable medium 60 such as a CD-R/DVD-R, a USB flush memory, a floppy disk, a portable HDD, an SD card storing multimedia contents or the like can be coupled to the client 50 or the file-sharing server 53. Thus, the client 50 can exchange files with the portable medium 60.

In principle, the client 50 is assigned to each user. However, a situation in which the client 50 is assigned to more than one user is assumable. To deal with such a case, the client 50 is configured to be capable of identifying and authenticating the users to figure out which user has used the client 50. Further, when several users use the client 50 by using a common account, account management is separately conducted so as to figure out associations between the users and accounts.

Subsequently, description will be given of function units which the file management system 100 configures/maintains on the basis of a program, for example. Here, the file management system 100 includes, in a storage: medium identification information with which a storage medium (in the example of FIG. 1, the external storage media 52a and 52b, and the portable medium 60) can uniquely be identified; a table 55 in which a correspondence relationship between a logical path set in each of the storage media and the corresponding medium identification information is described; and a terminal log database 56 storing therein file location information.

The file management system 100 includes a log acquisition unit 110. The log acquisition unit 110 detects an event occurring on a file stored in the storage medium, checks pieces of logical path information of the location of the file before and after the event in the table 55 to identify pieces of medium identification information of a storage medium in which the file is located before the event and of a storage medium in which the file is located after the event, and then stores the pieces of medium identification information as location information of the file in the terminal log database 56.

Further, the file management system 100 includes a table creating unit 111. Before the processing of the log acquisition unit 110, the table creating unit 111 accesses a storage medium set in each logical path to acquire medium identification information, identifies a correspondence relationship between each logical path and medium identification information, and then generates or updates the table 55.

Further, when the event is a move or copy of a file, the log acquisition unit 110 of the file management system 100 preferably stores, in the terminal log database 56, medium identification information of storage media corresponding to the source and the destination of the move of the file or the source and the destination of the copy of the file.

The log acquisition unit 110 of the file management system 100 preferably acquires, from the client 50 or the file-sharing server 53 (terminal) to which storage media in which the file is located before and after the event is coupled, PC identification information with which the terminal can be uniquely identified, and then stores, in the terminal log database 56, the PC identification information and the file name of the file on which the event has occurred, in addition to the medium identification information of the storage medium, as location information of the file.

Further, the file management system 100 preferably includes an information asset list generating unit 112. The information asset list generating unit 112 acquires the location information from the terminal log database 56; creates, for each event of each file, an entry including the name of a corresponding file, medium identification information of a storage medium storing the file, and PC identification information of a terminal with the storage medium coupled thereto; and stores the entries in an information asset list 23 included in a storage 20a.

Moreover, the information asset list generating unit 112 of the file management system 100 preferably creates the information asset list 23 for each file, and stores the entries separately for each file in the information asset list.

Moreover, the information asset list generating unit 112 of the file management system 100 preferably searches the information asset list 23 for the file name included in one of the entries, and, when the entry is not included in the information asset list 23, creates a new information asset list.

Moreover, the log acquisition unit 110 of the file management system 100 preferably detects an occurrence of an event of a coupling or an uncoupling between a terminal and a storage, and stores, in the terminal log database 56, storage medium information in which information on the occurrence time of the event is associated with the medium identification information of the storage medium and the PC identification information of the terminal to which the storage medium is coupled.

The file management system 100 preferably includes a storage medium list generating unit 113. The storage medium list generating unit 113 acquires the storage medium information from the terminal log database 56; creates an entry in which information on the occurrence time of the event of a coupling or an uncoupling between a terminal and a storage is associated with the medium identification information of the storage and the PC identification information of the terminal to which the storage medium is coupled; and then stores the entry in a storage medium list 24 included in the storage medium 20a.

The file management system 100 preferably includes a discard management unit 114. The discard management unit 114 acquires, from an input interface 27, medium identification information of a storage medium to be discarded; registers discard information in an entry in the storage medium list 24 corresponding to the storage medium; checks the medium identification information of the storage medium to be discarded, with the information asset list 23; and then registers deletion information in the entry of the file stored in the storage medium.

Further, the file management system 100 preferably includes a search unit 115. The search unit 115 receives a search request including date-and-time information and a file name from the input interface 27; performs a search in the information asset list 23 on the basis of the date-and-time information and the file name included in the search request as keys; identifies a storage medium in which a file corresponding to the file name is stored at date and time corresponding to the date-and-time information; and then outputs information on this storage medium as the location information of the file on the date and time.

Moreover, the search unit of the file management system 100 preferably lists, for each storage medium, pieces of location information of the files acquired by the search, and then outputs the listed pieces of location information to an output interface 28.

Moreover, the file management system 100 preferably includes a storage medium monitoring unit 116 when a file access monitoring process is executed on a storage medium, the file access monitoring process being for monitoring only file accesses based on logical paths without taking medium identification information of the storage medium as a process target, and for acquiring information on events in which a file access has occurred and a file access log including information on a logical path and date and time. The storage medium monitoring unit 116 monitors events of a coupling or an uncoupling of the storage medium; acquires a storage medium log including date-and-time information on the coupling or uncoupling, medium identification information of the storage medium and information on the logical path set in the storage medium; and then stores this storage medium log in the storage.

In this case, the file management system 100 preferably includes a log merging unit 117. The log merging unit 117 identifies a storage medium log corresponding to the date and time and the logical path indicated by the file access log; merges the storage medium log thus identified and the file access log; and then generates the terminal log including an event of a file access having occurred at the date and time, the name of a logical path being a destination of the event, and medium identification information of the storage medium.

Incidentally, in the first embodiment, the above-described function units are shared, as an example, by the client 50, the file-sharing server 53, the log server 10, and the file management server 20.

First, the client 50 or the file-sharing server 53 includes a log acquisition program 51 for monitoring an event performed by a user 1a or 1b on the client 50 or the file-sharing server 53 in the client 50 or the file-sharing server 53 and for recording, as a log, information on a change having occurred in an electronic file or the like in relation to the event. The log, which is a result recoded by using the log acquisition program 51, is stored in the terminal log database 56. Here, this log acquisition program 51 serves as the above-described log acquisition unit 110, the table creating unit 111, and the storage medium list generating unit 113.

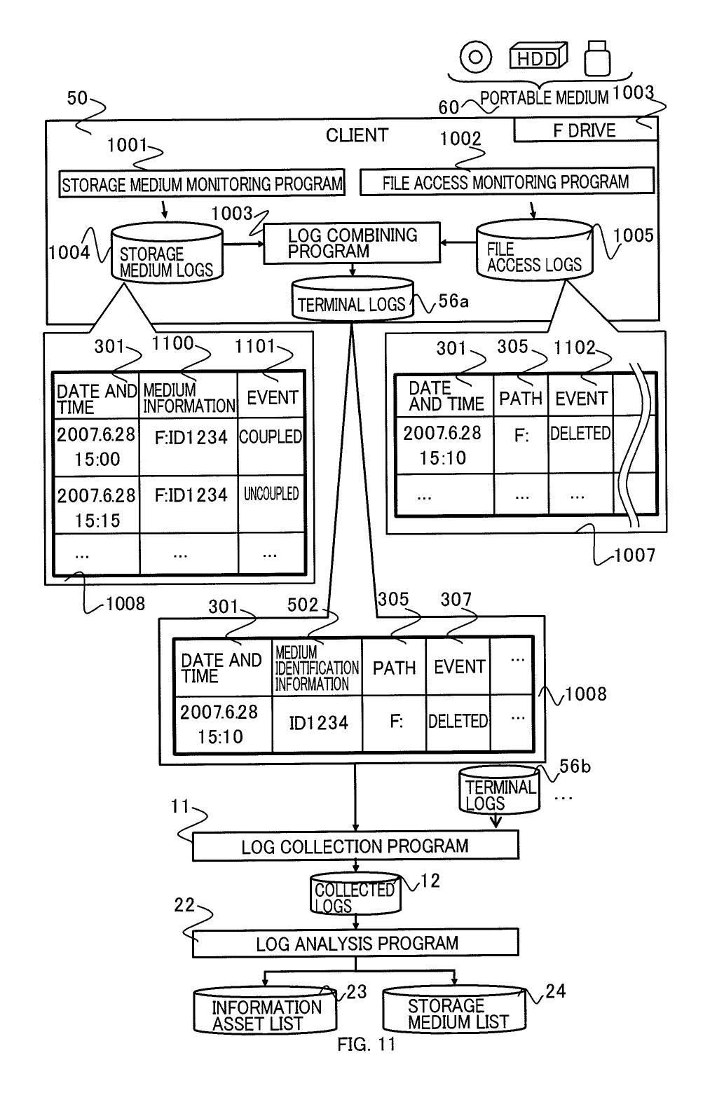

Further, the client 50 or the file-sharing server 53 can also include a storage medium monitoring program 1001, a file access monitoring program 1002, and a log merging program 1003 (refer to FIG. 11). The storage medium monitoring program 1001 serves as the above-described storage medium monitoring unit 116, and the log merging program 1003 serves as the above-described log merging unit 117.

In the log server 10, a log collection program 11 for collecting terminal logs 56a and 56b recorded by using the log acquisition program 51 operates so as to store collected logs 12, which are results obtained by the log collection program 11.

In the file management server 20, the collected logs 12 is analyzed as a target, and a log analysis program 22 for figuring out locations of files and use states of storage media in an organization operates to store therein the information asset list 23 and the storage medium list 24, which are results analyzed by the log analysis program 22. This log analysis program 22 serves as the information asset list generating unit 112 and the discard management unit 114.

Further, in the file management server 20, a file management program 21 operates, the file management program 21 being for receiving a request from a manager 2, referring to the information asset list 23, and then extracting the location of a file satisfying the request from the manager 2 operates. Here, a file in this patent document is intended for an information asset which is valuable to an organization, and is not intended for a system file or the like. This file management program 21 serves as the search unit 115.

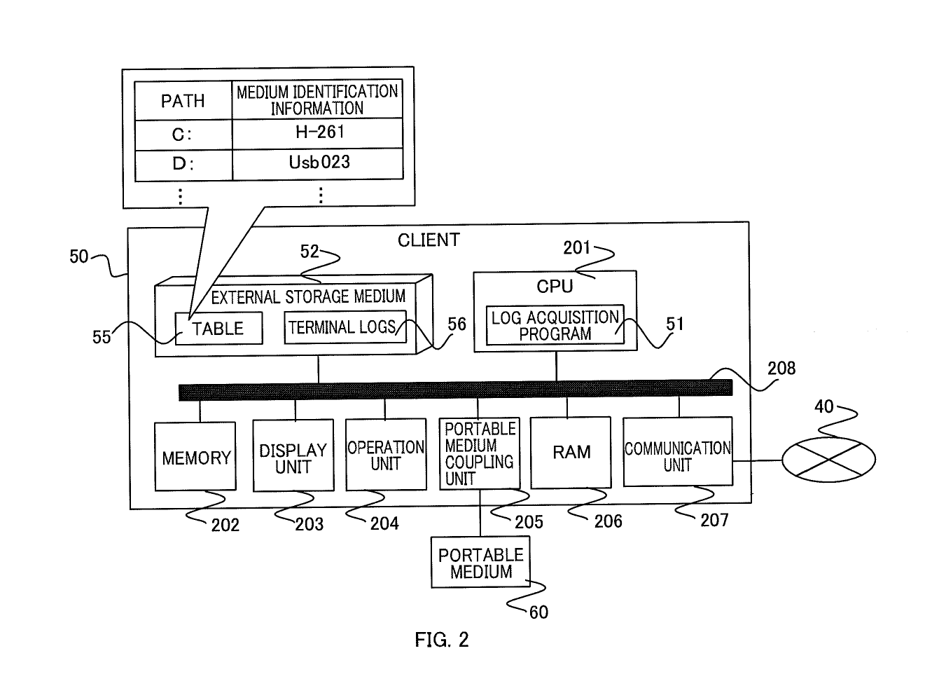

Next, a configuration of the client 50 will be described. FIG. 2 is a block diagram of the client 50 in the file management system 100. The client 50 includes: an external storage medium 52 storing the terminal log database 56 and the table 55; a CPU 201 executing the log acquisition program 51; a memory 202; a display unit 203 on which an input/output window is displayed; an operation unit 204 controlling an input/output; a portable medium coupling unit 205 for reading/writing data and the like stored in the portable medium 60; a RAM 206; a communication unit 207 communicating with the network 30 with or without wires; and a bus 208 coupling these devices and the like to each other. Here, the table 55 is generated in such a way that the log acquisition program 51 executes a function of the table generating unit, accesses storage media set in logical paths of the client 50 to acquire medium identification information, and consequently identifies a correspondence relationship between each of the logical paths and medium identification information, before processing by the log acquisition unit 110.

Further, the file-sharing server 53, the log server 10, and the file management server 20 each also have a hardware configuration similar to that of the client 50 shown in the block diagram in FIG. 2. However, the log server 10 and the file management server 20 do not always need to have the portable medium coupling unit 205.

Further, the above-described function units 110 to 117 and the like in the devices included in the file management system 100 may each be implemented as hardware, or as a program stored in an appropriate storage such as a memory or a hard disk drive (HDD). In this case, for an execution of a program, a CPU of the corresponding device reads the program from the storage medium, and then executes the program.

### Database Structure

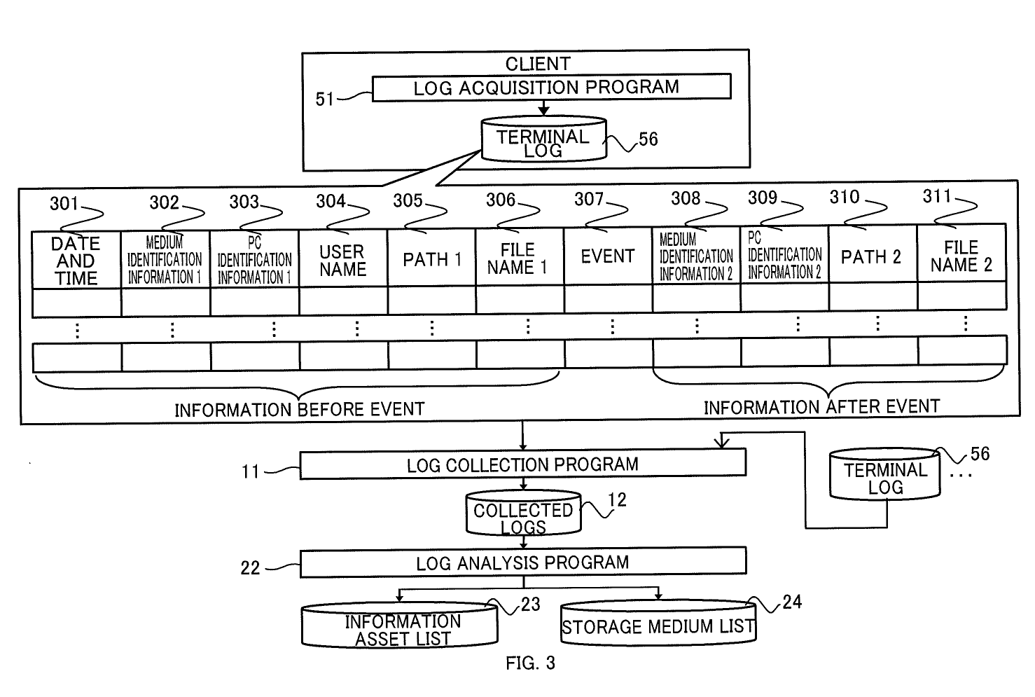

Next, data formats of the terminal log database 56, the collected log database 12, the information asset list 23, and the storage medium list 24 will be described with reference to FIGS. 3, 4, and 5. FIG. 3 shows data formats of the terminal log database 56 and the collected log database 12, and a data flow. The terminal log database 56 is generated in such a manner that the log acquisition program 51 monitors events such as operations on files stored in the client 50 and couplings and uncouplings of storage media (the external storage medium 52, the portable medium 60, and the like), and records the events on the storage (the external storage medium 52) of the client 50.

The terminal log database 56 is table data including 0 or more entries. In FIG. 3, Column 301 stores date and time indicating occurrence time of an event, Column 302 stores medium identification information 1 indicating a storage medium storing a file before occurrence of an event, Column 303 stores PC coupling information 1 indicating identification information on a client to which the storage medium indicated in Column 302 is coupled, Column 304 stores the name of a user having performed the event, Column 305 stores a path 1 (logical path) indicating the location of the file before the occurrence of the event, Column 306 stores a file name 1 indicating a file name before the occurrence of the event, Column 307 stores the event indicating an event type, Column 308 stores medium identification information 2 indicating a storage medium storing the file after the occurrence of the event, Column 309 stores PC coupling information 2 indicating identification information of a client to which the storage medium indicated in Column 308 is coupled, Column 310 stores a path 2 indicating the location of the file in Column 308, and Column 311 stores a file name 2 indicating a file name after the occurrence of the event.

Here, the medium identification information 1 (Column 302) and the medium identification information 2 (Column 308) are each information with which a storage medium can be uniquely identified in the file management system 100, e.g., a manufacturing number or a serial number which is provided in advance to the storage medium. When a storage medium, such as a CD-R, a floppy disk, or the like, does not have a unique identification number, storage medium identification can be made possible by separately providing a means for generating unique medium identification numbers in an organization is separately provided, and a medium identification number generated by the medium identification number generation means is written at the time of the writing of a file.

Further, the PC identification information 1 (Column 303) and the PC identification information 2 (Column 309) are each information with which a client can be uniquely identified in the file management system 100, and may be, for example, any one of the following formats, any combination thereof, or any other format.

“Computer Name”+“Path on Hard Disk”

“MAC Address”+“Path on Hard Disk”

“IP Address”+“MAC Address”+“Path on Hard Disk”

“Serial ID of Motherboard”+“Path on Hard Disk”

“Certificate of Security Chip”+“Path on Hard Disk”

When an event having occurred is one involving an e-mail, an message ID or the like with which an e-mail can be uniquely identified may be used for the file name 1 (Column 305) and the file name 2 (Column 311), while information on a destination of a mail such as a mail address may be recorded for the PC identification information 1 (Column 303) and the PC identification information 2 (Column 309).

The terminal log database 56 including the above-described configuration is recorded as the terminal log database 56a for each client or as a log database 56b for each file-sharing server 53, and the databases are collected in the log server 10 by the log collection program 11 to serve as the collected logs 12. The data format of the collected logs 12 is the same as that of the terminal log database 56. Here, the log collection program 11 causes a log to be transmitted to the log server 10 based on an operation flow of the log acquisition program 51 to be described later. However, a collection of information stored in the terminal log database 56 may regularly be performed, for example, each time the log acquisition program 51 acquires one entry of the terminal log database 56, each time the log collection program 11 is started, or once a day at certain time.

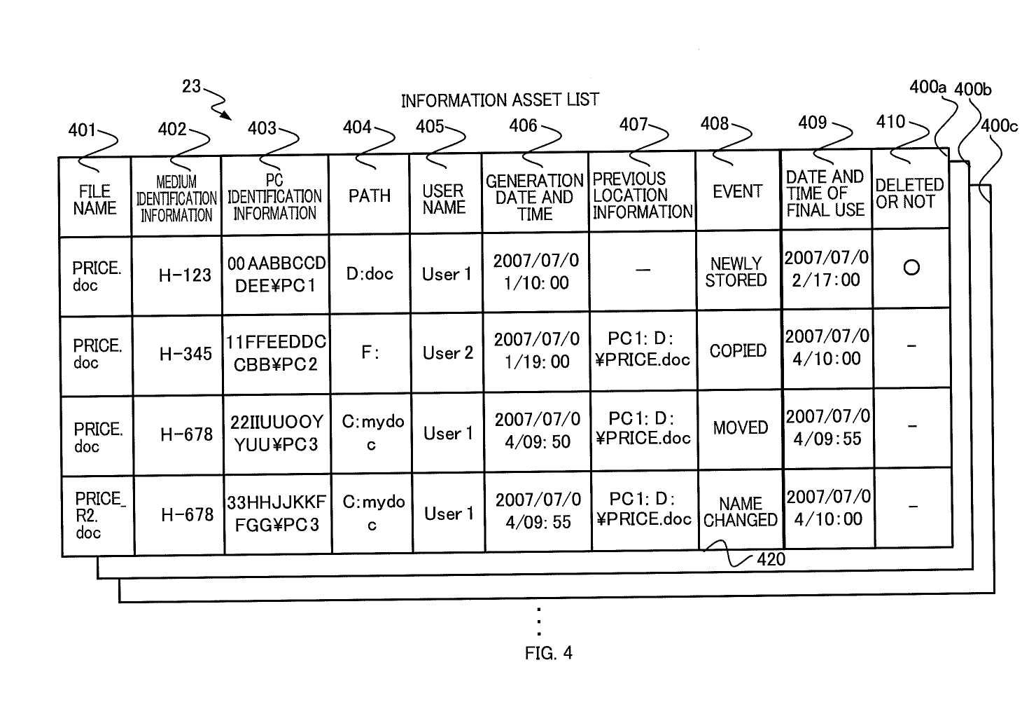

FIG. 4 shows a data format of the information asset list 23. The information asset list 23 records results related to information on files among results obtained through an analysis of the collected logs 12 by the log analysis program 22.

The information asset list 23 has different sheets (400a, 400b, 400c) corresponding to the number of different files. Further, the sheets 400 each are table data 420 including 0 or more entries. In the sheets 400, Column 401 stores the name of a file, Column 402 stores medium identification information indicating a storage medium storing the file, Column 403 stores PC coupling information indicating identification information of a client to which the storage medium indicated in the Column 402 is coupled, Column 404 stores a path of the file, Column 405 stores a user name, Column 406 stores generation date and time of the file, Column 407 stores previous location information indicating the location of the file before an event, Column 408 stores an event indicating the type of event having occurred, Column 409 stores date and time of last use indicating last date and time at which the file has been stored in the path indicated in the Column 404, and Column 410 stores information on deletion to manage whether the file is in a deleted state.

In the information asset list 23, a state in which a NULL value is entered in the previous location information (Column 407) indicates the case where the file is newly generated, while a state in which a NULL value is entered in the deletion information (Column 410) indicates the case where the file is still stored.

Further, a new sheet is created and is then added to the sheets 400 for a file found out not to be related to any files when the information asset list 23 is searched by the log analysis program 22, that is, a file copied or moved from a storage medium which has so far never been coupled to the network environment of the organization, or a newly created file. Here, since no sheet is registered immediately after installation of the file management system 100, the information asset list 23 is searched when any event 600 occurs on a file, and a file not on the list is added to the information asset list 23 as a new sheet. When operations such as replacement or formatting of a storage medium, and reinstalling of an OS are carried out, the identification information of the storage medium before copy or move of files is added to the information asset list 23 upon backup of the files to a different storage medium.

Using the above-described information asset list 23, it is possible to figure out storage states of files, scattered in the file management system 100 due to copies and moves, in storage media. Further, even when an encryption or a compression operation is performed or when a file name is changed, the information asset list 23 can manage the events on the same table.

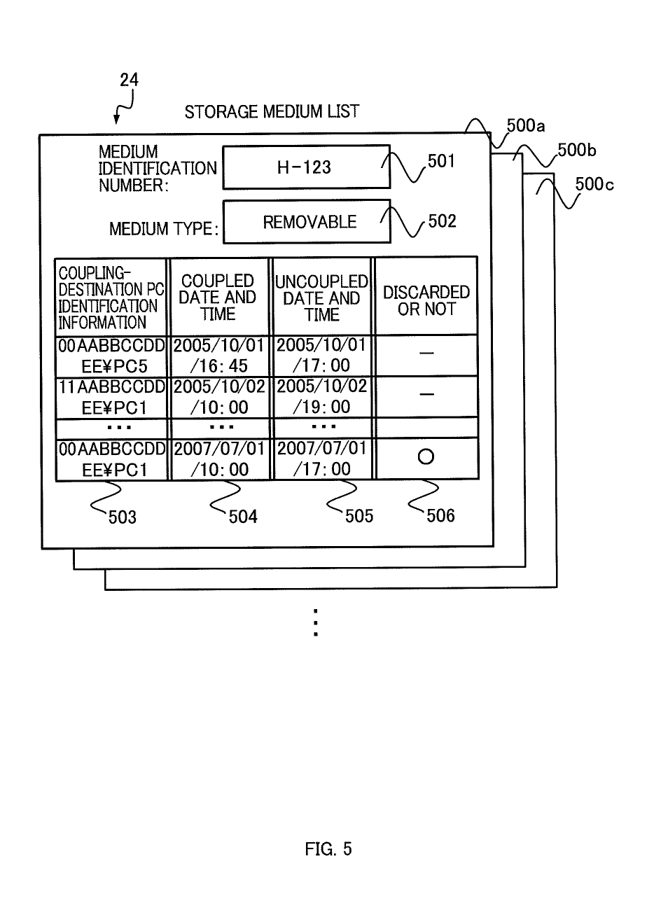

FIG. 5 shows a data format of the storage medium list 24. The storage medium list 24 records information related to storage media among results obtained through analysis of the collected logs 12 by the log analysis program 22.

The storage medium list 24 has different sheets 500a, 500b, 500c corresponding to the number of different storage media. Further, the sheets 500 are each table data including 0 or more entries, and each have a medium identification number 501, and type of medium 502 for identifying whether the storage medium is a removable disk or a storage medium included in a client. Thus, when a storage medium is identified, it is possible to identify whether the storage medium is one included in a client, or a portable one.

In addition, in each of the sheets (500a, 500b, 500c) of the storage medium list 24, Column 503 stores coupling-destination PC identification information indicating the client to which a storage medium is coupled, Column 504 stores coupling date and time indicating date and time at which the storage medium is coupled, Column 505 stores uncoupling date and time indicating date and time at which the storage medium is uncoupled, and Column 506 stores discard information indicating a state whether or not the storage medium is discarded.

Here, Column 504 and Column 505 show dates and times during which a coupling has been maintained. For example, for a storage medium included in a client, date and time when an OS is started and uncoupled date and time are recorded in the entries as coupled date and time and uncoupled date and time.

Further, in the log acquisition program 51, when a storage medium is physically removed and discarded, discard information cannot be acquired and, hence, a manager inputs the discard information of the storage medium through the input interface 27. A registration method for the case in which the storage medium is discarded will be described later.

By using the above-described storage medium list 24, it is possible to figure out which client a storage medium is coupled to and when it is done, as well as to figure out a replacement of a storage medium. Here, the storage medium list 24 and the information asset list 23 are in conjunction with each other. Accordingly, when discard information of the storage medium is registered in the storage medium list 24, deletion information is also registered for a file which is stored in the registered storage medium, in the information asset list 23, in conjunction with the discard information.

### PROCESS FLOW EXAMPLE 1

A practical procedure of a file management method according to the first embodiment will be described below with reference to the accompanying drawings. Various operations corresponding to the file management method to be described below are each performed by a program read into a RAM and the like of a group of devices (each having any one of the function units 110 to 117) included in the file management system 100 and then executed by a corresponding CPU. This program is composed of codes for performing various operations to be described below. Further, since the various function units 110 to 117 are executed by the log acquisition program 51, the log collection program 11, the file management program 21, the log analysis program 22, the storage medium monitoring program 1001, and the log merging program 1003, description below will be given mainly with respect to these programs for the sake of description.

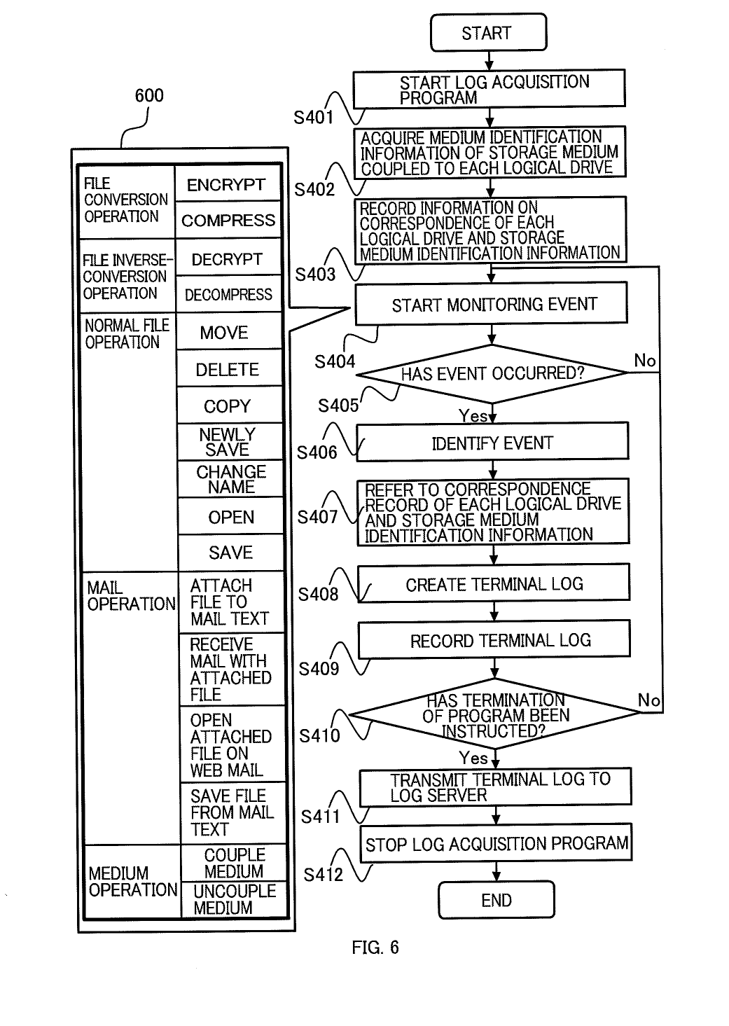

FIG. 6 is a view showing a process flow example 1 of a file management method according to the first embodiment. A description will be given below of an operation flowchart of the log acquisition program 51. The log acquisition program 51 of the client 50 is started (Step S401) along with starting an OS of the client 50, and storage medium identification information of a storage medium (the external storage medium 52, the portable medium 60, or the like) coupled to each logical drive of the client 50 is acquired (Step S402). Then, the acquired correspondence information between each logical drive and the storage medium identification information is recorded as the table 55 in the terminal log database 56a (Step S403).

Thereafter, various events 600 occurring in the client 50 are monitored by the log acquisition program 51 (Step S404), the events 600 including, for example, file conversion operations, file inverse conversion operations, normal file operations (copy, move, new registration, deletion, and the like), mail operations, and medium operations (coupling/decoupling to/from a storage medium, and the like) This monitoring process is performed by acquiring command information of a file operation instructed by a user by using the operation unit 204 of the client 50. Further, interfaces of the external storage medium 52 and the portable medium 60 of the client 50 are monitored so as to detect a coupling or an uncoupling of the storage medium and the like at the interfaces.

When one of the above-described events occurs (Step S405: Yes), the type of the event having occurred is identified, for example, by reading the command information, by the log acquisition program 51 (Step S406). Further, a logical drive (which can also be acquired from the command information or the like, e.g. extracting information containing logical paths F and C from a command instructing a move of a certain file in a drive F to a certain folder in a drive C) is checked with the table 55 (Step S407), whereby medium identification information of a storage medium and a logical path for the location of the file of an event target is identified to create a terminal log (Step S408). Thereafter, the terminal log is recorded in the terminal log database 56a (Step S409).

The log acquisition program 51 causes, for example, the process to return to Step S404 to keep on monitoring events until a program termination command is issued along with the termination of the OS of the client 50 or until the termination of the OS is detected (Step S410: No).

Meanwhile, in Step S410, when the termination command for the program is issued or when the termination of the OS is detected (Step S410: Yes), information stored in the terminal log database 56a (i.e., terminal log) acquired in the client 50 is transmitted to the log server 10 (Step S411), and the log acquisition program 51 is thereafter stopped (Step S412).

The above-described processes of the log acquisition program 51 are performed, whereby all events occurring in the client 50 can be recorded in the terminal log database 56a as a terminal log. Here, logs of events other than those shown in the event list 600 in FIG. 6 can also be acquired by using the above-described log acquisition program 51 (for example, by setting existing detection means in the log acquisition program 51 for each event).

The log collection program 11 by which the terminal log acquired by the log acquisition program 51 is collected may also be set to regularly collect terminal logs, instead of performing collection only in Step S411 in the operation flowchart of the log acquisition program 51. In this case, the log acquisition program 51 identifies identify the client 50 and the like coupled to the network 40 by requesting, of the file management server 20, address information on the network, such as IP addresses of the client 50 and the file-sharing server 53 coupled to the network 40, and thereby issues a log collection request to the client 50 and the file-sharing server 53 thus identified. For a terminal such as the client 50 from which a response to the log collection request has been made, the log collection program 11 operates to collect terminal logs included in the terminal log database 56 of the corresponding terminal in the log server 10. For a terminal from which no response has been made to the log collection request, the log collection program 11 issues an alert to the file management server 20 by assuming that the log acquisition program 51 is not included in the terminal. Thereafter, the file management server 20 preferably performs an installation of the log acquisition program 51.

### PROCESS FLOW EXAMPLE 2

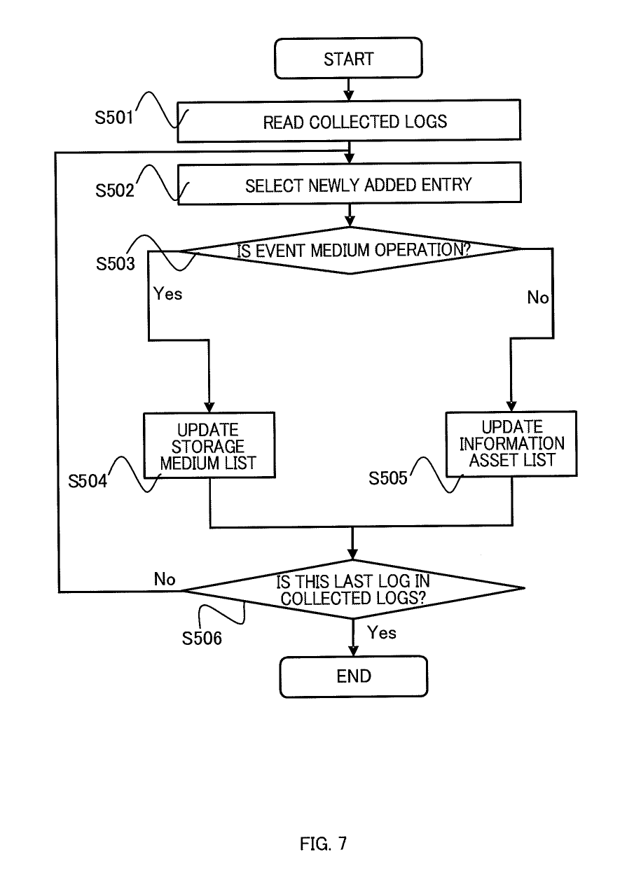

FIG. 7 is a view showing a process flow example 2 of the file management method according to the first embodiment. Next, description will be given of an operation flowchart of the log analysis program 22 included in the file management server 20. Firstly, the collected logs 12 are read from the log server 10 (Step S501), and newly added records are selected from the collected logs 12 one at a time (Step S502), by the log analysis program 22 of the file management server 20.

Next, referring to the event of each selected record, it is identified, by the log analysis program 22, whether or not the event is related to a medium operation, i.e. whether or not the event is related to a conversion operation, an inverse conversion operation, a file operation, or a mail operation (Step S503).

When the event of the selected record is related to a medium operation (refer to the event list 600 of FIG. 6) (Step S503: Yes), an entry related to the corresponding storage medium is updated in the storage medium list 24 (Step S504).

On the other hand, when the event of the record is not related to any medium operation (Step S503: No), the event is supposed to be related to a file, so that an entry on the corresponding file in the information asset list 23 is updated (Step S505).

After updating an entry in accordance with the type of the event, it is checked whether there is any record not yet selected in the new records in the collected logs 12 (Step S506). When the process is completed for the last record in the collected logs 12 (Step S506: Yes), the log analysis program 22 is terminated. On the other hand, when the process has not been completed for the last record in the collected logs 12 (Step S506: No), the process returns to Step S502 to perform the same steps.

By the processes of the log analysis program 22, various events on files are collected for each file and can be managed in the information asset list 23. In addition, as in the case of files, events occurring on storage media are collected for each storage medium by the processes of the log analysis program 22, and can be managed in the storage medium list 24.

Further, the log analysis program 22 is automatically executed when receiving a command from the manager 2, or once or several times a day. After the information asset list 23 is updated by the log analysis program 22, the information asset list 23 thus updated is used for the tracking of files. Thus, the collected logs 12 having already been referred to by the log analysis program 22 are not to be referred to later, so that the collected logs 12 may be discarded.

### PROCESS FLOW EXAMPLE 3

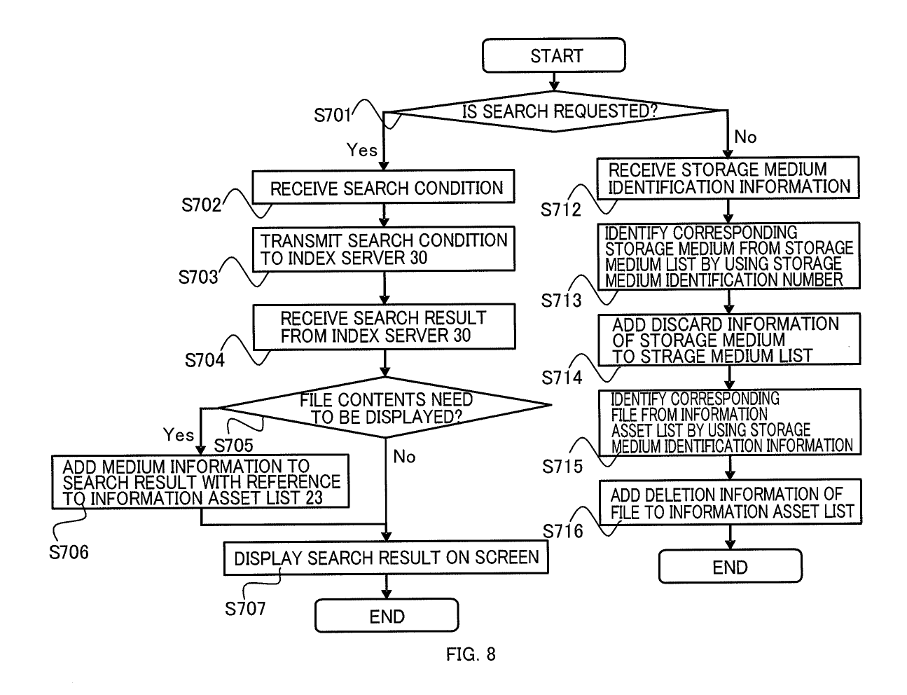

FIG. 8 is a diagram showing a process flow example 3 of the file management method according to the first embodiment. Next, description will be given of an operation flowchart of the file management program 21 included in the file management server 20. A search of a file or a storage medium, or a discard information registration process of a storage medium, is performed by the file management program 21, on the basis of a request of the manager 2 received through the input interface 27 of the file management server 20.

The file management program 21 first receives a search or a discard information registration process of a storage medium through the input interface 27 as a request from the manager 2 (Step S701). When the received request from the manager 2 is “search,” the file management program 21 receives a search condition for identifying a file or a storage medium intended to be searched out, through the input interface 27 (Step S702).

Subsequently, the file management program 21 transmits the search condition received in Step S702 to be transmitted to the index server 30 (Step S703). After completion of a search in the index server 30, the file management program 21 receives a search result from the index server 30 (Step S704).

After the search result from the index server 30 is received in Step S704, the received search condition inputted from the manager 2 is referred to. Thereby, when the received search condition includes a condition indicating the contents of a file (Step S705: Yes), the information asset list 23 is searched on the basis of a logical path and a file name described in the search result. Thus, storage medium information of a storage medium storing a file in which the logical path and the file name are contained is identified in the information asset list 23, and is thereafter added to the search result (Step S706) Then, the search result is displayed on the output interface 28 by the file management program 21 (Step S707). In addition, for the search condition, a person, a period, a file name, a PC name, a storage medium identification number, or the like may be used alone, or a combination of these may be used.

By the above-described operations, a file or a storage medium satisfying the search condition inputted by the manager 2 can be searched out by using medium identification information of the storage medium that is a storage destination.

Next, description will be given of a registration process of discard information of a storage medium in the case where the manager 2 does not select “search” in Step S701. In this case, first, the file management program 21 receives the medium identification information of the storage medium which is to have discard registration from the manager 2 through the input interface 27 (Step S712).

Subsequently, the storage medium list 24 is searched by the file management program 21 on the basis of the medium identification information received in Step S712, to identify a corresponding storage medium (Step S713). Further, the discard information of the identified storage medium is added to a corresponding entry in the storage medium list 24 (Step S714). Thus, in the storage medium list 24 shown in FIG. 5, “o” is added to a corresponding field for discard information in Column 506.

After the storage medium list 24 is updated in Step S714, the information asset list 23 is referred to, and a file stored in the storage medium corresponding to the medium identification number received from the manager 2 is thereby identified, by the file management program 21 (Step S715). Thereafter, deletion information is added to a corresponding entry for the file thus identified, in the information asset list 23 (Step S716). Thus, in the information asset list 23 shown in FIG. 4, “o” is added to a corresponding field for deletion information in Column 410.

An addition process of the deletion information is set to add “o” to a corresponding field for deletion information in Column 509 in the information asset list 23, and to update discard time of a storage medium by using file deletion time.

The operation flowchart of the file management program 21 has been described above. However, user authentication means may be provided so that a person other than the manager 2 can perform operations of the processes, instead. Further, the search result described above can be displayed by using an existing search engine in the index server 30 without modification.

### WINDOW EXAMPLE 1

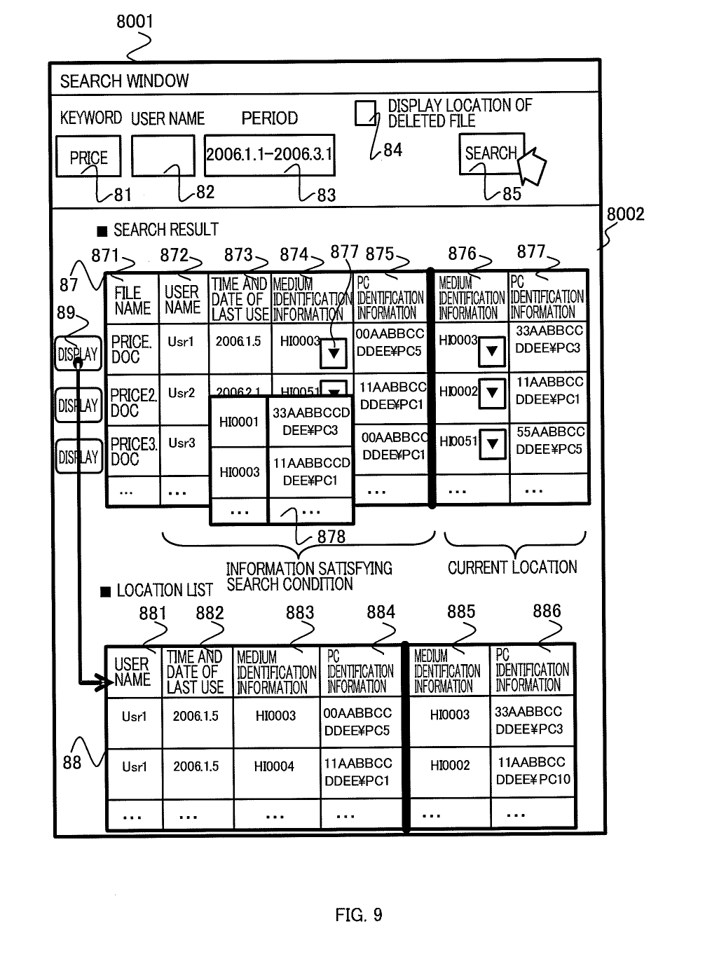

FIG. 9 shows an example of a display window in a case where a search of a file or a storage medium is performed by the file management program 21. Description will be given below of this search window. A search window 8001 displays a result of a search of a file or a storage medium performed by the manager 2. As an input interface of a search condition, the search window 8001 receives at least one input, such as a keyword 81, a file name 82, a period 83 during which a file intended to be searched out has existed, or the like, from the manager 2. Further, in a case where the manager 2 also intends to display a file which has already been deleted, as a search result, the search window 8001 receives the instruction when a check is marked in a checkbox 84. After the manager 2 inputs a search condition, when a search button 85 is clicked, the result satisfying the search condition received through the input is displayed on the search window 8001 by the file management program 21.

Next, description will be given of a search result window 8002 in which a result satisfying the search condition is displayed. In the search result window 8002, first, a search result table 87 is displayed. The search result table 87 includes: Column 871 indicating the name of a file satisfying a search condition; Column 872 indicating the name of a user who has used the file shown in Column 871; Column 873 indicating date and time at which the file satisfying the search condition has been lastly used; Column 874 indicating storage medium identification information on a medium in which the file was stored at the date and time satisfying the search condition; Column 875 indicating identification information of a client or the like to which the storage medium shown in Column 874 has been coupled; Column 876 indicating identification information of a storage medium in which the file shown in Column 871 is currently stored; and Column 877 indicating identification information of a client or the like to which the storage medium shown in Column 876 is coupled.

In addition, when the manager 2 clicks to pull down a menu 877 of the search result table 87, a location list 878 of locations at which a file of a selected entry is stored is displayed. Further, for each entry of the search result table 87, a display button 89 for displaying a list of locations of the corresponding file of a search result is provided, and a location list table 88 showing the locations and history of the selected file, i.e., the location list 878 of locations at which the file is stored is displayed when the manager 2 clicks the display button 89. Thus, the manager 2 can identify a storage medium in which a file satisfying the search condition is stored.

### WINDOW EXAMPLE 2

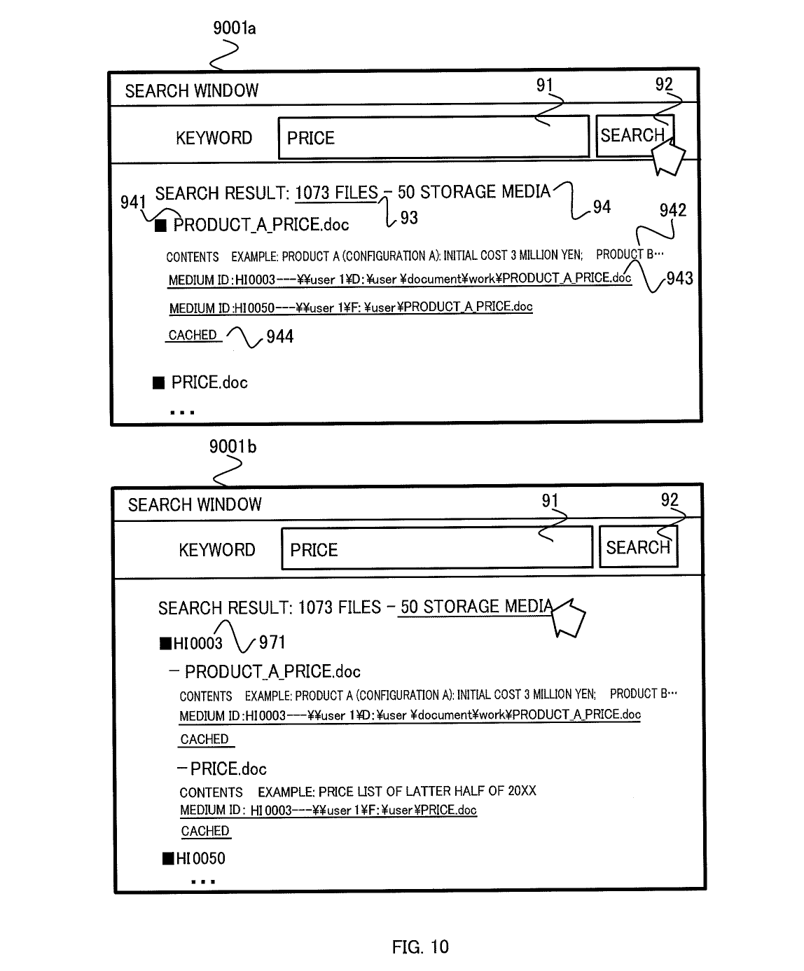

FIG. 10 shows another display configuration of a search window. Description will be given below of a window showing a search result. A search window 9001a receives an input of a keyword to serve as a search condition at a keyword reception field 91 in the window. When the manager 2 clicks a search button 92, a result obtained by performing a search with the keyword as a search condition is displayed in the search window 9001a.

Here, this search result is created, for example, in a HTML format, and specifically created in the following procedure. Firstly, the file management program 21 receives a keyword to serve as a search condition. Thereafter, a search result corresponding to the received keyword is then identified in the index server 30, and an HTML file to serve as a search result window is thereby generated.

Subsequently, by the file management program 21, the source of the generated HTML file indicating a search result is read; a storage medium (one in which a corresponding file is stored) to be a search result is identified by referring to the information asset list 23 on the basis of a path name and a file name in the source; the source of the HTML file is overwritten with medium identification information of the identified storage medium; and the HTML file is thus updated. Consequently, even the storage medium can be included in a search result as the location information of the file.

In the file search window 9001a, the following items are displayed as a search result for each of search results: the number 93 of files searched out; the number 94 of storage media storing the searched-out files; a file name 941 of a file satisfying a search condition; contents 942 of a file; a path 943 indicating the location of a file including storage medium information; and a cache 944 indicating a link to cached information of the file. The manager 2 clicks each displayed content of a file containing contents the manager 2 desires to see, so that information linked to the content can be acquired.

In addition, when the number 94 of storage media storing files satisfying the search condition displayed in the file search window 9001a is clicked, the files satisfying the search condition are sorted on the basis of the storage media, and a file search window 9001b is displayed, by the file management program 21.

In the search window 9001b, the same information as that displayed in the file search window 9001a is displayed for each storage medium satisfying the search condition. Here, a display order of the media thus sorted may be the descending order from a storage media storing a largest number of files satisfying the search condition, or may be another order. The manager 2 can use any one of the search windows shown in FIGS. 9 and 10.

### Second Embodiment

FIG. 11 is a diagram showing a log acquisition procedure of a second embodiment. Here, a configuration of a file management system of the second embodiment and a data flow will be described. In the first embodiment, the log acquisition program 51 included in the client 50 serves to monitor an event to acquire a terminal log. By contrast, in the second embodiment, it is assumed that a file access monitoring program 1002 by which a file access for an event related to a file or a storage medium is acquired has already been installed in the client 50. Even under this condition, the same log as a terminal log of a terminal log database 56 can be created by including a storage medium monitoring program 1001 and a log merging program 1003 without modifying the file access monitoring program 1002. A configuration and programs will be described in detail below.

First, file access log 1005 of events (refer to FIG. 6) related to files and storage media is acquired by the file access monitoring program 1002. The file access log 1005 is composed of information including at least date and time (Column 301) indicating date and time at which an event occurred, a path name (Column 305) of a file, and an event (Column 1102) other than that related to a medium operation among the events 600 of FIG. 6.

The storage medium monitoring program 1001 is a program by which only couplings and uncouplings of storage media are monitored, and a storage medium log 1004 is acquired. The storage medium log 1004 is composed of information on events of couplings and uncouplings of storage media such as: information on a coupling or an uncoupling date and time (Column 301); medium identification information (Column 1100) including a drive letter of a drive to which the storage medium is coupled, and identification information of the storage medium; and an event (Column 1101) indicating event information of a coupling or an uncoupling.

The log merging program 1003 is for collecting file access logs 1005 and the storage medium logs 1004 respectively recorded by the file access monitoring program 1002 and the storage medium monitoring program 1001. In addition, date and time (Column 301) at which an event has occurred, and a drive letter recorded in a path (Column 305) on which the event has occurred are acquired by referring to the file access log 1005, and an entry on a storage medium corresponding to the acquired date and time and the acquired drive letter is identified from the storage medium logs 1004 to generate a terminal log.

Hence, it is possible to identify a storage medium storing a file acquired by the file access monitoring program 1002, and to generate the same terminal log as that acquired by the log acquisition program 51 described in the first embodiment. The log collection program 11 and the log analysis program 22 after the acquisition of the terminal log, the collected logs 12, and the data configurations of the information asset list 23 and the storage medium list 24 are the same as those of the first embodiment.

### Third Embodiment

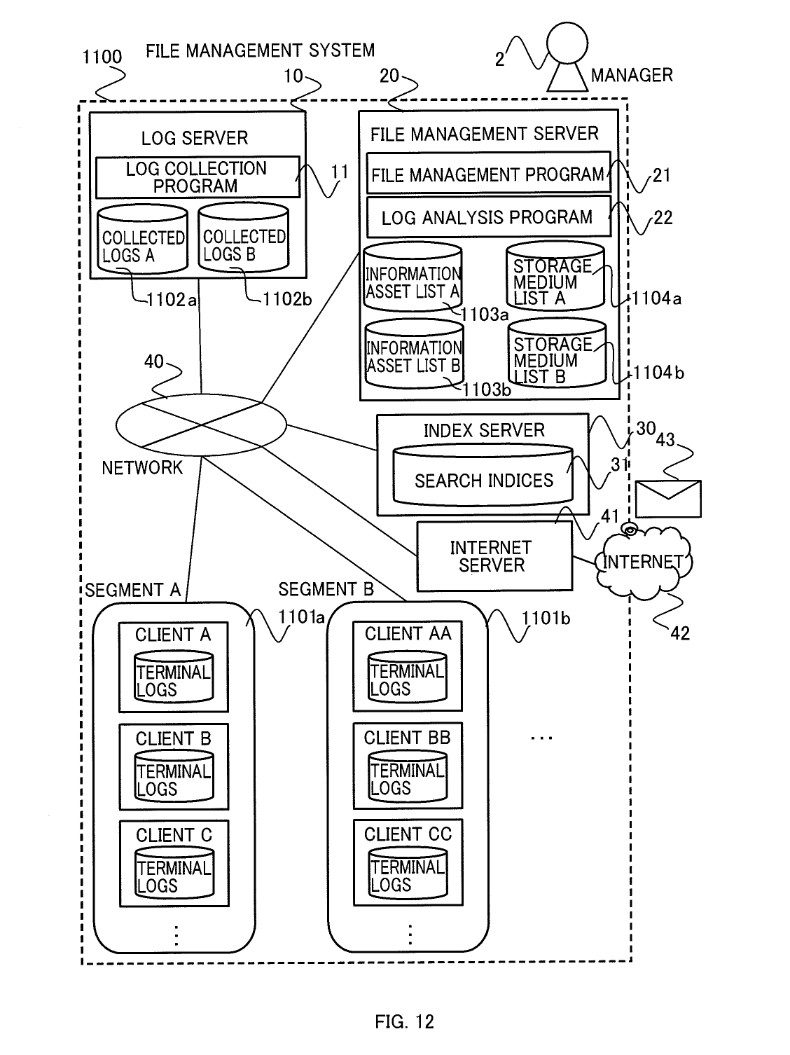

FIG. 12 is a configuration diagram of a file management system 1100 according to a third embodiment. The file management system 1100 has a system configuration including multiple segments 1101 in each of which one or more clients are coupled in a network environment. In this example, for the sake of description, the file management system 1100 is assumed to have a configuration including a segment A (1101a) and a segment B (1101b). In addition, these segments are coupled to each other with a network 40. Terminal logs collected respectively in the segment A (1101a) and the segment B (1101b) are collected in a collected logs A (1102a) and collected logs B (1102b) of the log server 10, respectively, through the network 40. Further, even in a file management server 20, an information asset list A (1103a) and an information asset list B (1103b), or a storage medium list A (1104a) and a storage medium list B (1104b) are updated for each segment.

By taking this system configuration, the file management server 20 is capable of managing information assets for the unit of segment. For example, in a situation of a large corporation having a large number of clients, this system configuration allows an increase in overall process efficiency compared to a case of performing all log collections and subsequent processes for each client company-wide, since processes can be performed only for a related segment such as a related division. In addition, for a move of information asset over segments, from the segment A (1101a) to the segment B (1101b), information of a move destination is acquired by referring to the information asset list 1103 and the storage medium list 1104 for update, by the file management program 21 of the file management server 20. Further, operation flows of the log acquisition program 51, the log collection program 11, and the like are the same as those of the first embodiment.

### Fourth Embodiment

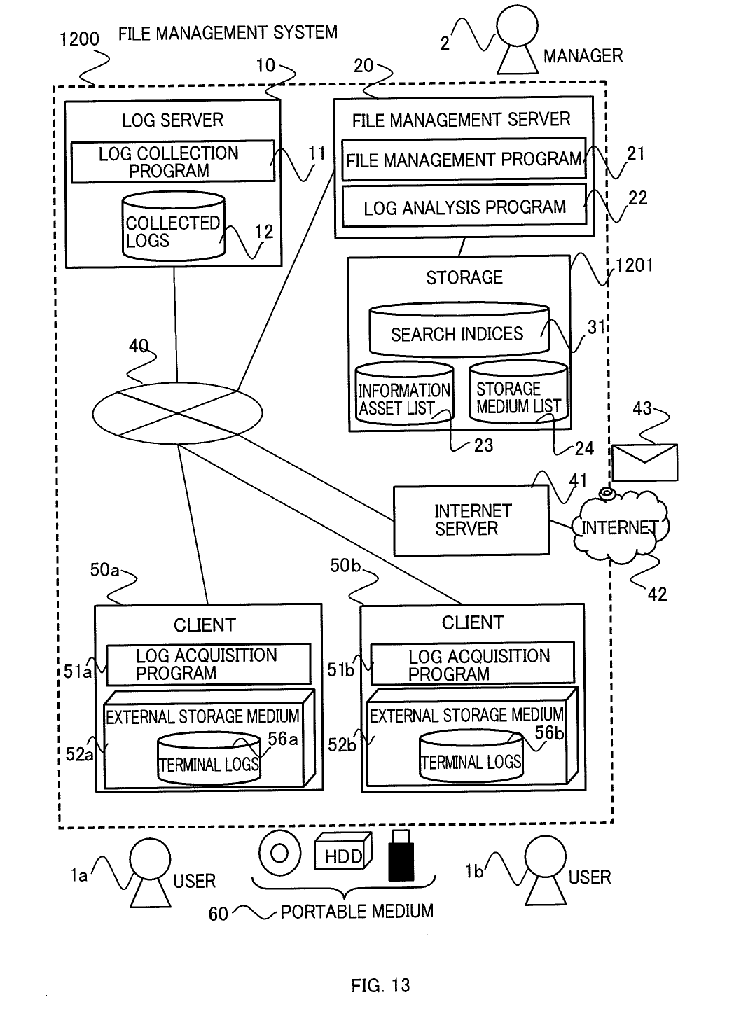

FIG. 13 shows a configuration diagram of a file management system 1200 according to a fourth embodiment. The system of this embodiment has a configuration including the information asset list 23, the storage medium list 24, and the search index 31 in a storage 1201.

The storage 1201 includes a write once read many (WORM) function and a continuous data protection (CDP) function. With these functions, each log stored in the storage 1201 can be saved without falsification. Further, by using the CDP function, it is easier to refer to contents of a file at a desired time designated by the user. In addition, the file may be archived in the storage 1201 in accordance with the level of importance of a file. Operation flows of the log acquisition program 51, the log collection program 11, and the like are the same as those of the first embodiment.

According to each of the above-described embodiments, it is possible to track the location of a file somewhere in a computer system (including external storages and portable medium) of an organization via networks and portable devices over a long period of time, by identifying a storage medium storing the file. Thus, the location of a file can quickly be identified depending on human experiences and memories as little as possible. In addition, since not only a logical path but also a storage medium storing the file are simultaneously managed as the location of a file, a move and deletion of the file along with a replacement and discard of a device can also be tracked.

These file management systems can be used as a tool supporting management of various risks which an organization is facing. In preparation for the prevention of information leakage and for the investigation of a cause of leakage having occurred, such a system can be used as a tool for supporting a person in charge in the security division for file management and file tracking, in management of files in an information system and environment therearound.

In preparation for an e-discovery in a lawsuit or in an audit, these systems can be used as a tool supporting a storage medium investigation by a security consultant, a system planner of the information system division, or the like in management of files in an information system and environment therearound.

Furthermore, these systems can be used as a tool proving business legitimacy in an outsourcing company performing the activities with business information and confidential information from a client company.

In other words, it is possible to identify a storage medium storing a file, and to detect a location move of a file stemming from coupling/uncoupling and/or replacement of a storage medium.

As described above, the present invention has been described in detail on the basis of the embodiments. However, the present invention is not limited to the above embodiments, and various changes may be made therein without departing from the scope of the invention.

The specification and drawings are, accordingly, to be regarded in an illustrative rather than a restrictive sense. It will, however, be evident that various modifications and changes may be made thereto without departing from the spirit and scope of the invention as set forth in the claims.

We claim:

1. A file management system managing locations of files in a computer system, the system comprising:
a storage storing a table in which a correspondence relationship between medium identification information enabling a unique identification of a storage medium and a logical path set for the storage medium is described, and storing a terminal log database in which information on file location is stored; and
an arithmetic unit executing a log acquisition process in which an event having occurred on a file stored in the storage medium is detected, pieces of information on logical path of the file location before and after the event, respectively, are checked with the table, pieces of medium identification information of storage media in which the file is located before and after the event, respectively, are identified, and the pieces of medium identification information are then stored in the terminal log database as the information on file location.

2. The file management system according to claim 1, wherein, before the log acquisition process, a table creation process is performed in which: a storage medium set for each logical path is accessed to acquire medium identification information; a correspondence relationship between each of the logical paths and the acquired medium identification information is identified; and the table is thereby generated or updated.

3. The file management system according to claim 1, wherein, in the log acquisition process, when the event is a move or a copy of the file, pieces of medium identification information of corresponding storage media serving respectively as a move destination and a move source of the file, or serving respectively as a copy destination and a copy source of the file, are stored in the terminal log database.

4. The file management system according to claim 1, wherein, in the log acquisition process, pieces of PC identification information enabling unique identifications of terminals to which storage media with the file located therein before and after the event are acquired respectively from the terminals, and the pieces of PC identification information and a file name of the file on which the event has occurred are stored, as the information of file location, in the terminal log database, in addition to the pieces of medium identification information of the storage media.

5. The file management system according to claim 4, wherein an information asset list generation process is performed in which: the location information is acquired from the terminal log database; an entry is generated, for each event of each file, the entry including a name of the file, medium identification information of a storage medium storing the file, and PC identification information of a terminal coupled to the storage medium; and the entry is then stored in an information asset list included in the storage.

6. The file management system according to claim 5, wherein, in the information asset list generation process, the information asset list is created for each file, and the entry is stored separately for each file in the information asset list.

7. The file management system according to claim 5, wherein, in the information asset list generation process, when the information asset list is searched for a file name included in the entry and the entry is not found in the information asset list, a new information asset list is created.

8. The file management system according to claim 4, wherein, in the log acquisition process, an occurrence of an event of a coupling or an uncoupling between a terminal and a storage medium is detected, and storage medium information is stored in the terminal log database, the storage medium information including information on the occurrence time of the event associated with each of medium identification information of the storage medium and PC identification information of the terminal to which the storage medium is coupled.

9. The file management system according to claim 8, wherein a storage medium list generation process is performed in which: the storage medium information is acquired from the terminal log database; an entry is generated, the entry including information on an occurrence time of an event of a coupling or an uncoupling between a terminal and the storage medium, associated with each of the medium identification information of the storage medium and the PC identification information of the terminal to which the storage medium is coupled; and the entry is stored in a storage medium list included in the storage.

10. The file management system according to claim 4, wherein a discard management process is performed in which: medium identification information of a storage medium to be discarded is acquired through an input interface; discard information is registered in an entry of the storage medium list corresponding to the storage medium to be discarded; the medium identification information of the storage medium to be discarded is checked with the information asset list; and deletion information is registered in an entry of a file stored in the storage medium.

11. The file management system according to claim 1, wherein a search process is performed in which: a search request including date-and-time information and a file name is received through an input interface; a search is performed on the information asset list by using, as keys, the date-and-time information and the file name included in the search request; a storage medium storing a file corresponding to the file name at date and time corresponding to the date-and-time information is identified; and information on the storage medium thus identified is outputted to an output interface as location information on the file at the date and time.

12. The file management system according to claim 11, wherein pieces of the location information of each file acquired by the search are listed for each storage medium, and are then outputted to the output interface, in the search process.

13. The file management system according to claim 1, wherein, when a file access monitoring process is performed on the storage medium, the file access monitoring process including that: only a file access based on a logical path is monitored without using medium identification information of the storage medium as a process target; and a file access log including event information on a file access having occurred, a logical path, and date-and-time information is acquired,
a storage medium monitoring process is performed in which: an event of a coupling or an uncoupling of the storage medium is monitored; a storage medium log including date-and-time information of the coupling or uncoupling, medium identification information of the storage medium, and information of a logical path set for the storage medium is acquired; and the acquired storage medium log is stored in the storage, and
a log merging process is performed in which: a storage medium log corresponding to the date and time and the logical path indicated by the file access log is identified; the storage medium log thus identified and the file access log are merged; and the terminal log including the event of the file access having occurred at the date and time, the name of a logical path serving as a destination of the event, and medium identification information of the storage medium is generated.

14. A file management method, wherein
a computer, managing locations of files in a computer system, includes a storage storing a table in which a correspondence relationship between medium identification information enabling a unique identification of a storage medium and a logical path set for the storage medium is described, and storing a terminal log database in which information on file location is stored, and an arithmetic unit, and
the computer executes a log acquisition process in which an event having occurred on a file stored in the storage medium is detected, pieces of information on logical path of the file location before and after the event, respectively, are checked with the table, pieces of medium identification information of a storage medium in which the file is located before and after the event, respectively, are identified, and the pieces of medium identification information are then stored in the terminal log database as the information on the file location.

15. A file management program causing a computer including, for managing locations of files in a computer system, a storage storing a table in which a correspondence relationship between medium identification information enabling a unique identification of a storage medium and a logical path set for the storage medium is described, and storing a terminal log database in which information on file location is stored; and an arithmetic unit, to execute the steps of:
detecting an event occurring on a file stored in the storage medium;
checking, with the table, pieces of information on logical path of the file location before and after the event, respectively;
identifying pieces of medium identification information of storage media in which the file is located before and after the event, respectively; and
storing the pieces of medium identification information in the terminal log database as the information on file location.
